(19) United States
(12) Patent Application Publication
(10) Pub. No.: US 2021/0241094 A1
(43) Pub. Date: Aug. 5, 2021

(54) RANK SELECTION IN TENSOR DECOMPOSITION BASED ON REINFORCEMENT LEARNING FOR DEEP NEURAL NETWORKS

(71) Applicants: Baidu USA, LLC; Baidu.com Times Technology (Beijing) Co., Ltd., Beijing (CN)

(72) Inventors: Zhiyu CHENG, Sunnyvale, CA (US); Baopu LI, Santa Clara, CA (US); Yanwen FAN, Beijing (CN); Yingze BAO, Mountain View, CA (US)

(73) Assignees: Baidu USA LLC, Sunnyvale, CA (US); Baidu.com Times Technology (Beijing) Co., Ltd., Beijing, CA (CN)

(21) Appl. No.: 16/979,522

(22) PCT Filed: Nov. 26, 2019
(86) PCT No.: PCT/CN2019/120928

§ 371 Date: Sep. 10, 2020

(51) Int. Cl. G06N 3/08; G06N 3/04

(52) U.S. Cl. CPC G06N 3/08; G06N 3/04

(57) ABSTRACT

Tensor decomposition can be advantageous for compressing deep neural networks (DNNs). In many applications of DNNs, reducing the number of parameters and computation workload is helpful to accelerate inference speed in deployment. Modern DNNs comprise multiple layers with multi-array weights where tensor decomposition is a natural way to perform compression—in which the weight tensors in convolutional layers or fully-connected layers are decomposed with specified tensor ranks (e.g., canonical ranks, tensor train ranks). Conventional tensor decomposition with DNNs involves selecting ranks manually, which requires tedious human efforts to finetune the performance. Accordingly, presented herein are rank selection embodiments, which are inspired by reinforcement learning, to automatically select ranks in tensor decomposition. Experimental results validate that the learning-based rank selection embodiments significantly outperform hand-crafted rank selection heuristics on a number of tested datasets, for the purpose of effectively compressing deep neural networks while maintaining comparable accuracy.

### TECHNICAL FIELD

The present disclosure relates generally to systems and methods for computer learning that can provide improved computer performance, features, and uses. More particularly, the present disclosure relates to systems and methods for improved of deep learning models.

### BACKGROUND

Deep neural networks have achieved great successes in many domains, such as computer vision, natural language processing, recommender systems, etc. As capabilities of machine learning models grow, their potential uses also expand. New areas of application are expanding each day.

However, machine learning models often require significant resources, such as memory, computational resources, and power. This high resource demand has limited the use of machine learning techniques because, unfortunately, in many situations, only resource-constrained devices are available. For example, mobile phones, embedded devices, and Internet of Things (IoT) devices are extremely prevalent, but they typically have limited computational and power resources.

If a model's size could be reduced, its corresponding resources requirements will generally also be reduced. But, reducing a model's size is not a trivial task. Determining how to reduce a model's size is complex. Furthermore, a model's size may be reduced but then its performance may be severely impacted.

Accordingly, what is needed are new approaches for reducing a model's resource demands without significantly impacting the model's performance.

### SUMMARY

According to a first aspect, some embodiments of the present disclosure provide a computer-implemented method for selecting ranks to decompose weight tensors of one or more layers of a pretrained deep neural network (DNN), the method includes: embedding elements related to one or more layers of the pretrained DNN into a state space; for each layer of the pretrained DNN that is to have its weight tensor decomposed, initializing an action with a preset value; iterating, until a stop condition has been reached, a set of steps including: for each layer of the pretrained DNN that is to have its weight tensor decomposed, having an agent use at least a portion of the embedded elements and a reward value from a prior iteration, if available, to determine an action value related to a rank for the layer; responsive to each layer of the pretrained DNN that is to have its weight tensor decomposed having an action value: for each layer of the pretrained DNN that is to have its weight tensor decomposed, decomposing its weight tensor according to its rank determined from its action value; and performing inference on a target dataset using the pretrained DNN with the decomposed weight tensors to obtain a reward metric, which reward metric is based upon inference accuracy and model compression due to the decomposed weight tensors; and responsive to a stop condition having been reached, outputting ranks for each layer of the pretrained DNN that had its weight tensor decomposed corresponding to a best reward metric.

According to a second aspect, some embodiments of the present disclosure provides a non-transitory computer-readable medium or media including one or more sequences of instructions which, when executed by at least one processor, causes steps for selecting ranks to decompose weight tensors of one or more layers of a pretrained deep neural network (DNN) to be performed, the steps including: embedding elements related to one or more layers of the pretrained DNN into a state space; for each layer of the pretrained DNN that is to have its weight tensor decomposed, initializing an action with a preset value; iterating, until a stop condition has been reached, a set of steps include: for each layer of the pretrained DNN that is to have its weight tensor decomposed, having an agent use at least a portion of the embedded elements and a reward value from a prior iteration, if available, to determine an action value related to a rank for the layer; responsive to each layer of the pretrained DNN that is to have its weight tensor decomposed having an action value: for each layer of the pretrained DNN that is to have its weight tensor decomposed, decomposing its weight tensor according to its rank determined from its action value; and performing inference on a target dataset using the pretrained DNN with the decomposed weight tensors to obtain a reward metric, which reward metric is based upon inference accuracy and model compression due to the decomposed weight tensors; and responsive to a stop condition having been reached, outputting ranks for each layer of the pretrained DNN that had its weight tensor decomposed corresponding to a best reward metric.

According to a third aspect, some embodiments of the present disclosure provides a system, the system includes: one or more processors; and a non-transitory computer-readable medium or media including one or more sets of instructions which, when executed by at least one of the one or more processors, causes steps to be performed, the steps includes: embedding elements related to one or more layers of the pretrained DNN into a state space; for each layer of the pretrained DNN that is to have its weight tensor decomposed, initializing an action with a preset value; iterating, until a stop condition has been reached, a set of steps including: for each layer of the pretrained DNN that is to have its weight tensor decomposed, having an agent use at least a portion of the embedded elements and a reward value from a prior iteration, if available, to determine an action value related to a rank for the layer; responsive to each layer of the pretrained DNN that is to have its weight tensor decomposed having an action value; for each layer of the pretrained DNN that is to have its weight tensor decomposed, decomposing its weight tensor according to its rank determined from its action value; and performing inference on a target dataset using the pretrained DNN with the decomposed weight tensors to obtain a reward metric, which reward metric is based upon inference accuracy and model compression due to the decomposed weight tensors; and responsive to a stop condition having been reached, outputting ranks for each layer of the pretrained DNN that had its weight tensor decomposed corresponding to a best reward metric.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

FIG. 1 graphically depicts four tensor decomposition formats: (a) canonical polyadic (CP) decomposition, a 3rd-order case; (b) Tucker decomposition, a 3^{rd}-order case; (c) tensor train (TT) decomposition, the general Nth-order case; and (d) tensor ring (TR) decomposition, the general Nth-order case.

FIG. 2 depicts an overview of a rank selection scheme based on reinforcement learning for tensor decomposition in deep neural networks, according to embodiments of the present disclosure.

FIG. 3 depicts a rank search procedure, according to embodiments of the present disclosure.

FIG. 4 depicts a methodology for updating the training of a deep neural network in which at least one or more of the weight tensors have been decomposed, according to embodiments of the present disclosure.

FIG. 5 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state.

Any headings used herein are for organizational purposes only and shall not be used to limit the scope of the description or the claims. Each reference/document mentioned in this patent document is incorporated by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### A. General Introduction

Despite machine learning methods growth in applications and abilities, their reach is being limited in some areas due to their high demand for computational resources—processors, memory, and power. While more and more smart devices are being developed and deployed in ever increasing ways and locations, these devices are typically resource-constrained devices, such as mobile phones, embedded devices, and Internet of Things (IoT) devices. Thus, if a model's size could be reduced, its corresponding resources requirements will generally also be reduced. By reducing the resource requirements, without severely impacting its performance, a deep learning model may be more broadly deployed.

Deep neural networks tend to be over-parameterized for a given task. That is, the models contain more parameters than are needed to obtain an acceptable level of performance. As such, some attempts have been directed to addressing this over-parameterized problem.

Tensor decomposition has been demonstrated to be an effective method for solving many problems in signal processing and machine learning. It is an effective approach to compress deep convolutional neural networks as well. A number of tensor decomposition methods, such as canonical polyadic (CP) decomposition, Tucker decomposition, tensor train (TT) decomposition, tensor ring (TR) decomposition have been studied. The compression is achieved by decomposing the weight tensors with trainable parameters in layers, such as convolutional layers and fully-connected layers. The compression ratio is mainly controlled by the tensor ranks (e.g., canonical ranks, tensor train ranks) in the decomposition process. However, it remains little studied as how to best select tensor ranks such that one can achieve better compression ratio while not significantly hurting the performance of the deep neural networks. Conventionally, the tensor ranks are selected manually by heuristics, and it requires tremendous human efforts and engineering hours to fine-tune the rank selections and achieve reasonable compression ratio and accuracy trade-off.

In this patent document, embodiments of a novel rank selection using reinforcement learning for tensor decomposition are presented for compressing weight tensors in each of a set of layers (such as fully connected layers, convolutional layers, and/or other layers) in deep neural networks. In one or more embodiments, the results of a tensor ring ranks selection by a learning-based policy as described herein are better than a lengthy conventional process of human tweak. Embodiments herein leverage reinforcement learning to select tensor decomposition ranks to compress deep neural networks. Some of the contributions of the disclosure in this patent document include the following:

(1) Embodiments of reinforcement learning-based rank selection for tensor decomposition are presented for compressing one or more layers in deep neural networks.

(2) In one or more embodiments, a deep deterministic policy gradient (DDPG), which is an off-policy actor-critic algorithm, is applied for continuous control of the tensor ring rank, and a state space and action space for compressing deep neural networks by tensor ring decomposition were also designed and applied.

(3) Experimental results using benchmark datasets validate tested embodiments by showing improvement over hand-crafted rank selection heuristics for decomposing convolutional layers in deep neural networks.

This patent document is organized as follows: Section B introduces a number of tensor decomposition techniques with particular focus on tensor ring decomposition and its applications in compressing deep neural networks. Section C describes embodiments of tensor rank selection mechanisms based on reinforcement learning. Deployment embodiments are discussed in Section D. Experimental results are summarized in Section E. Some conclusions are provided in Section F, and various computing system and other embodiments are provided in Section G.

### B. Tensor Decomposition and its Application in Neural Networks

### 1. Tensor Decomposition

Modern deep neural networks, such as convolutional neural networks (CNN), often contain millions of trainable parameters and consume hundreds of megabytes of storage and require high memory bandwidth. Tensor decomposition is known to be an effective technique to compress layers, such as fully connected layers and convolutional layers, in deep neural networks such that the layer parameter size is dramatically reduced.

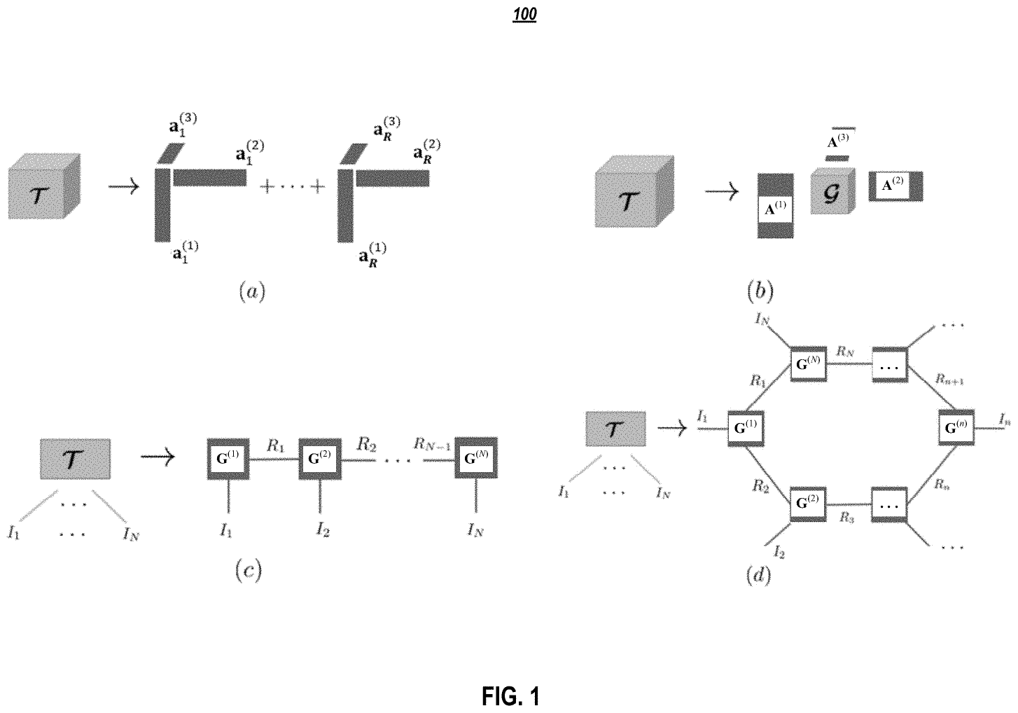

There have been different forms of tensor decomposition for compressing deep neural networks. FIG. 1 graphically depicts four tensor decomposition formats: (a) CP decomposition, a 3rd-order case; (b) Tucker decomposition, a 3rd-order case; (c) tensor train (TT) decomposition, the general Nth-order case; and (d) tensor ring (TR) decomposition, the general Nth-order case.

TR decomposition can be seen as an extension of the TT decomposition, and it aims to represent a high-order tensor by a sequence of 3rd-order tensors that are multiplied circularly. Given a tensor [symbol] ∈ [symbol] ^{I}^{₁}^{×I}^{₂}^{× . . . ×I}^{_{N}}, [symbol] can be decomposed in TR-format as:

[symbol]

ᵢ_{₁}_{,i}_{₂}_{, . . . ,i}_{_{N}}≈Σᵣ_{₁}₌₁^{R}^{₁}Σᵣ_{₂}₌₁^{R}^{₂} . . . Σᵣ_{_{N}}₌₁^{R}^{_{N}} [symbol] ᵣ_{₁}_{,i}_{₁}_{,r}_{₂}¹ [symbol] ᵣ_{₂}_{,i}_{₂}_{,r}_{₃}² [symbol] ᵣ_{_{N}}_{,i}_{_{N}}_{,r}_{_{N+1}}^{N}=Tr{G⁽¹⁾[i₁]·G⁽²⁾[i₂]· . . . ·G^{(N)}[i_{N}]} (1)

where { [symbol] ⁿ}ₙ₌₁^{N} is a collection of cores (or auxiliary tensors) with [symbol] ⁿ∈ [symbol] ^{R}^{ₙ}^{×I}^{ₙ}^{×R}^{ₙ₊₁}. Note the last tensor core is of size R_{N}×I_{N}×R₁, i.e., R_{N+1}=R₁, which relaxes the rank constraint of R_{N+1}=R₁=1 in tensor train decomposition. Tr denotes trace operation.

Tensor ring format can be considered as a linear combination of tensor train format, and it has the property of circular dimensional permutation invariance and does not require strict ordering of multilinear products between cores due to the trace operation. Therefore, intuitively, it offers a more powerful and generalized representation ability compared to tensor train format. In this patent document, embodiments comprise using tensor ring decomposition to compress deep convolutional neural networks, which will be discussed next.

### 2. Tensor Ring Decomposition in Neural Network Layers

While discussions herein refer to convolution layers, it shall be noted that convolution layers are used by way of example and that embodiments herein may be applied to other types of neural network layers. In deep neural networks, the convolutional layer performs the mapping of a 3rd-order input tensor to a 3rd-order output tensor with convolution of a 4th-order weight tensor. Let [symbol] ∈ [symbol] ^{H×W×I} denote the input tensor, [symbol] ∈^{K}^{₁}^{×K}^{₂}^{×I×O} denote the weight tensor, and [symbol] ∈ [symbol] ^{H′×W′×O} denote the output tensor. The mapping may be described as follows:

$${𝒴}_{{h}^{′} , {w}^{′} , o} = {\sum }_{{k}_{1} = 1}^{{K}_{1}} {\sum }_{{k}_{2} = 1}^{{K}_{2}} {\sum }_{i = 1}^{I} {𝒲}_{{k}_{1} , {k}_{2} , i , o} {𝒳}_{h , w , i} \qquad ( 2 )$$

Note that the following equations hold regarding the spatial size of the input and output tensors:

$${H}^{′} = \frac{H + 2 P - {K}_{1}}{S} + 1 {W}^{′} = \frac{W + 2 P - {K}_{2}}{S} + 1 \qquad ( 3 )$$

where P is the zero padding size, and S is the stride size.

In deep neural networks, the 4th-order weight tensor in a convolutional layer may be decomposed to four 3rd-order tensors using TR decomposition. Since the weight tensor's spatial dimension (e.g., K₁=K₂=3) is usually small and the spatial information is preferably maintained, the weight tensor is not decomposed in spatial modes. By merging the spatial dimensions of two 3rd-order tensors into a 4th-order tensor, the convolution operation in neural networks may be described by tensor ring decomposed tensors as follows:

$$\begin{matrix}{h , w , {r}_{2} , {r}_{3}}_{} = {\sum }_{i = 1}^{I} {𝒳}_{h , w , i} {𝒢}_{{r}_{2} , i , {r}_{3}}^{( 2 )} & ( 4 ) \\ {{h}^{′} , {w}^{′} , {r}_{3} , {r}_{1}}_{} = {\sum }_{{k}_{1} = 1}^{{K}_{1}} {\sum }_{{k}_{2} = 1}^{{K}_{2}} {\sum }_{{r}_{2}}^{R} {ℳ}_{h , w , {r}_{2} , {r}_{3}} {𝒢}_{{r}_{1} , {k}_{1} , {k}_{2} , {r}_{2}}^{( 1 )} & ( 5 ) \\ {𝒴}_{{h}^{′} , {w}^{′} , o} = {\sum }_{{r}_{1}}^{R} {\sum }_{{r}_{3}}^{R} {𝒩}_{{h}^{′} , {w}^{′} , {r}_{3} , {r}_{1}} {𝒢}_{{r}_{3} , o , {r}_{1}}^{( 3 )} & ( 6 )\end{matrix}$$

Where [symbol] and [symbol] are intermediate tensors, and it is assumed all tensor cores have the same TR-rank R. Note if the input channel I and output channel O are large, one can further decompose [symbol] ⁽²⁾ and [symbol] ⁽³⁾, respectively.

The reduced parameter size Pᵣ for a given layer with TR-rank R may be expressed as:

$${P}_{r} = {\sum }_{i = 1}^{N} {d}_{i} {R}^{2} \qquad ( 7 )$$

where dᵢ is one of the N factors that are used to factorize the weight tensor. In comparison, the original weight tensor contains Πᵢ₌₁^{N} dᵢ parameters.

The TR-ranks affect the trade-off between the number of parameters and accuracy of the representation, and consequently in deep neural networks, the model size and accuracy. How to select the TR-ranks to compress weight tensors in convolutional layers while not adversely affecting the model accuracy too much is an important question. In one or more embodiments, this issue is addressed by using reinforcement learning, which is introduced next.

### C. Embodiments of Tensor Rank Selection Via Reinforcement Learning

In this section, embodiments of a framework of using reinforcement learning to select TR-ranks for decomposing one or more layers in deep neural networks are presented.

### 1. Embodiments of Reinforcement Learning and Actor-Critic Model

In one or more embodiments, reinforcement learning is leveraged for efficient search over action space for the TR decomposition rank used in each layer of a set of layers from a neural network. In one or more embodiments, continuous action space is used, which is more fine-grained and accurate for the decomposition, and the deep deterministic policy gradient (DDPG) is used for continuous control of the tensor decomposition rank, which is directly related to the compression ratio. DDPG is an off-policy actor-critic method and is used in embodiments herein, but it shall be noted that other reinforcement learning methods may also be employed, including without limitation, proximal policy optimization (PPO), trust region policy optimization (TRPO), Actor Critic using Kronecker-Factored Trust Region (ACKTR), normalized advantage functions (NAF), among others.

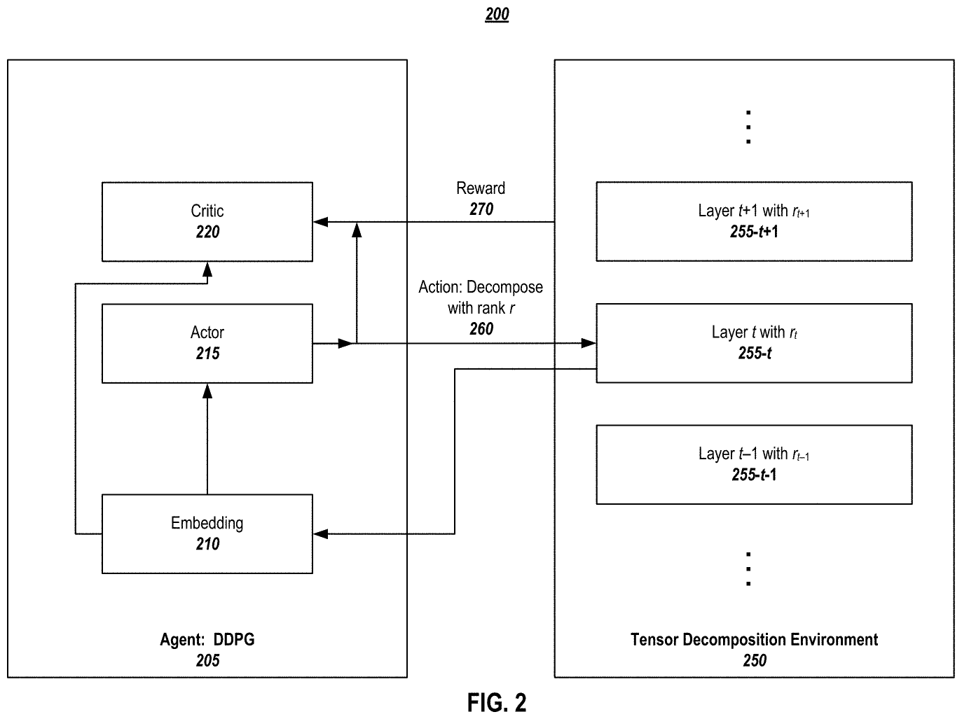

FIG. 2 graphically depicts the overall process of rank selection in decomposing one or more layers of a neural network, according to embodiments of present disclosure.

As depicted in FIG. 2 comprises an agent 205, which may be a deep deterministic policy gradient (DDPG) agent. DDPG may be considered as a combination of deep Q-learning network (DQN) and actor-critic (AC) network; it has the advantage of coping with continuous action state space with fast convergence ability. In one or more embodiments, DDPG comprises two major parts, an actor 215 and a critic 220. The actor 215 aims for the best action 260 for a specific state, and the critic 220, which receives a reward 270 based upon the inference accuracy and compressed model size due to the decomposition of a prior iteration, is utilized to evaluate a policy function estimated by the actor based on an error, such as the temporal difference (TD) error. In one or more embodiments, experience replay and separate target network from DQN are also employed in the whole structure of DDPG to enable a fast and stable convergence. In addition, to facilitate the exploration process for actions, in one or more embodiments, noise may be added on the parameter space, action space, or both.

In one or more embodiments, the state space in the reinforcement learning framework is designed as follows:

{i,n,c,h,w,s,k,params(i),aᵢ₋₁} (8)

where i is the layer index, n×c×h×w is the dimension of the weight tensor, s is the stride size, k is the kernel size, params(i) is the parameter size of layer i, and aᵢ₋₁ is the action of the previous layer (e.g., 255−t−1). These embeddings in the state space help the agent distinguish different convolutional layers. In the DDPG agent 205, a continuous action space may be used (e.g., a∈(0, 1]), which is related to the tensor ring rank in a given layer since it is a major factor that indicates the compressibility.

Tensor decomposition environment typically comprises multiple layers of a DNN to be decomposed with learned ranks for each layer that is to be decomposed. In one or more embodiments, it interacts with the DDPG agent in the following manner. The environment provides a reward, which is related to the modified pretrained model accuracy and model size, to the DDPG agent. In one or more embodiments, for each layer to be decomposed, a set of embeddings is provided to the DDPG agent, which in return gives an action to the layer to be decomposed in the environment.

### 2. Rank Search Procedure Embodiments

In one or more embodiments, the DDPG agent 205 searches for the TR-rank in decomposing the weight tensor in each layer (e.g., 225−x) that it to be decomposed, according to a reward function, which may be defined as the ratio of inference accuracy and model size, i.e., higher accuracy and smaller model size will provide more incentives for the agent to search for a better rank.

An embodiment of a detailed rank search procedure is described below in METHODOLOGY 1 as applied on, for example, a convolution neural network.

METHODOLOGY 1: TR rank search based on DDPG

Given: Pretrained model with N convolutional layers
Ensure: Build state embedding such that each element is
normalized within [0,1]
Ensure:
Initialize action for each layer with a preset value

repeat
Visit each of N convolutional layers, and agent takes an
action with rank r.
If all N layers are visited, decompose each layer with
learned rank and run model inference on target dataset, and
get a reward which is a function of inference accuracy and
compressed model size.
Agent takes the reward and starts new search.
until preset M episodes reached
Output learned ranks with the best reward.

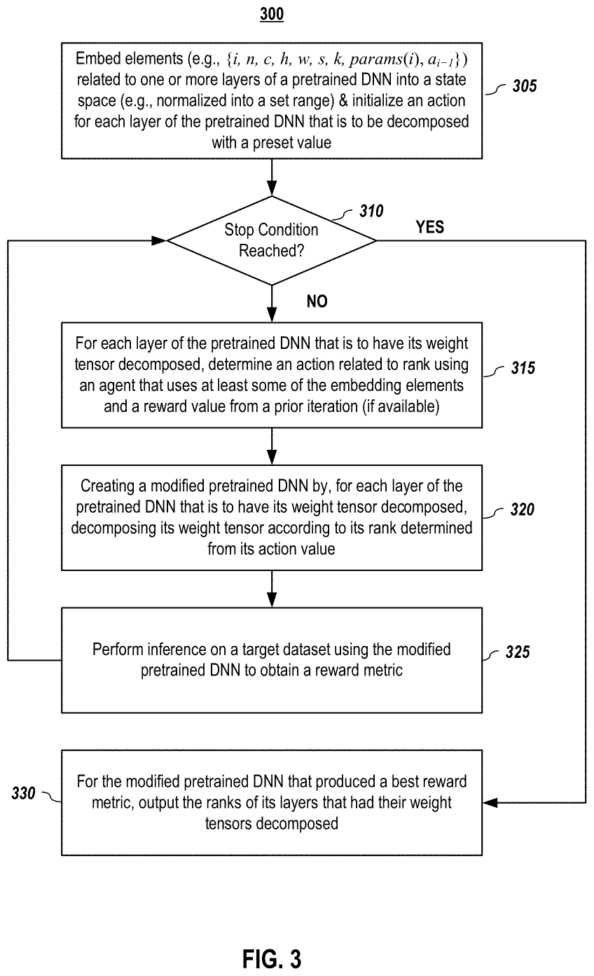

FIG. 3 depicts an alternative methodology, according to embodiments of the present disclosure. In one or more embodiments, a computer-implemented method for selecting ranks to decompose weight tensors of one or more layers of a pretrained deep neural network (DNN) comprises the following steps. As shown in FIG. 3, elements related to one or more layers of the pretrained DNN are embedded (305) into a state space. The elements related to the pretrained DNN may include, for each layer that is to have its weight tensor decomposed: an layer index; dimensions of its weight tensor; a stride size; a kernel size; a parameter size; and an action associated with a previously layer. In one or more embodiments, embedding elements into a state space involves normalizing the elements to be within a range, such as between zero and one. Also, in one or more embodiments, for each layer of the pretrained DNN that is to have its weight tensor decomposed, an action may be initialized (305) with a preset value.

Having initialized the system, a set of steps may be iterated (310), until a stop condition has been reached. In one or more embodiments, for each layer of the pretrained DNN that is to have its weight tensor decomposed, an agent (e.g., 205) determines (315) an action value (e.g., 260) related to a rank for the layer using at least a portion of the embedded elements and a reward value (e.g., 270) from a prior iteration, if available. That is, on the first pass, there is not a reward value from a prior iteration, and in such a case, no reward value may be used or a reward value may be set (e.g., a pre-set/initialized value or a randomly selected value). When each layer of the pretrained DNN that is to have its weight tensor decomposed has an action value assigned to it, each such layer's weight tensor are decomposed (320) according to its rank determined from its action value. It shall be noted that, alternatively, the weight tensor for each layer may be decomposed as it is assigned its action value. In one or more embodiments, the action value is a value from a continuation action space, and the action value is converted into an integer rank number. One skilled in the art shall recognize that there are multiple ways to convert the action value into an integer rank. For example, in one or more embodiments, rank=round (action*20), i.e., the action value times 20 and then rounded to the nearest integer. In any event, a modified pretrained DNN—that is, the pretrained DNN with its decomposed weight tensors—is created. Inference may be performed (325) using a target dataset on this modified DNN to obtain a reward metric. In one or more embodiments, the reward metric is based upon inference accuracy and model compression due to the decomposed weight tensors.

When a stop condition has been reached, for the modified pretrained DNN that had the best reward metric, its ranks for its decomposed layers are output (330). Alternatively, or additionally, the modified pretrained DNN that had the best reward metric may be output. In one or more embodiments, a stop condition may include: (1) a set number of iterations have been performed; (2) an amount of processing time has been reached; (3) convergence (e.g., the difference between reward metrics of consecutive iterations is less than a first threshold value); (4) divergence (e.g., the performance of the reward metric deteriorates); and (5) an acceptable reward metric has been reached.

### D. Embodiments of Deploying the Modified DNN

Given the modified DNN with its decomposed weight tensor, in one or more embodiments, it may be deployed for inference. By decomposing at least one or more layers' weight tensors of the DNN, the DNN has effectively undergone a form of compression, which will allow the DNN to be deployed into systems that may not have had the computing resources to deploy the DNN in its original state.

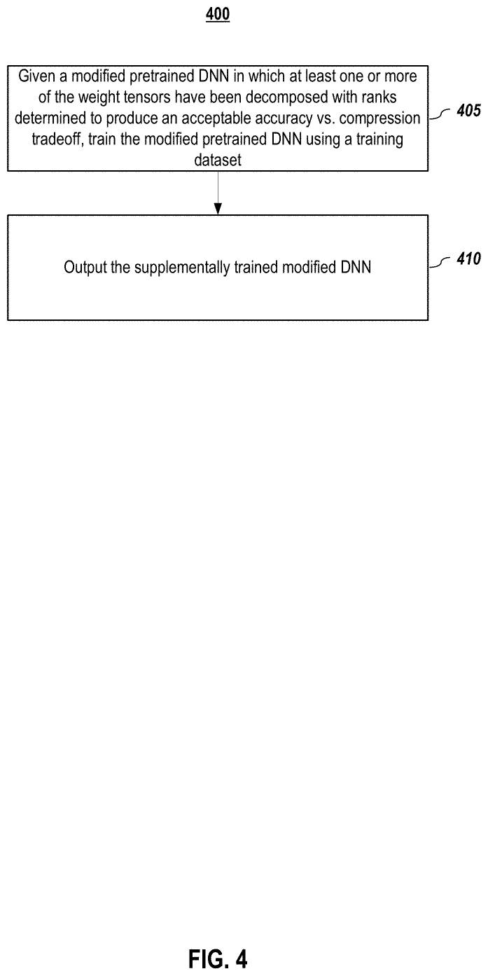

In one or more embodiments, the performance of the modified DNN may be improved by performing supplemental training before deployment. FIG. 4 depicts a methodology for updating the training of a deep neural network in which at least one or more of the weight tensors have been decomposed, according to embodiments of the present disclosure. As depicted in FIG. 4, given a modified pretrained DNN, in which at least one or more of the weight tensors have been decomposed with ranks determined to produce an acceptable accuracy vs. compression tradeoff, the DNN may be trained (405) using a training dataset. The training dataset may the same dataset that was used to initially train the DNN or may be a different training dataset. Following the supplemental training, the modified DNN may be output and deployed for use.

### E. Some Experimental Results

In this section, experiments were conducted on two benchmark datasets for image classification, i.e., CIFAR10 and CIFAR100, using ResNet-20 and ResNet-32 to validate the proposed framework and evaluate the performance of embodiments of the rank selection methodology.

It shall be noted that these experiments and results are provided by way of illustration and were performed under specific conditions using a specific embodiment or embodiments; accordingly, neither these experiments nor their results shall be used to limit the scope of the disclosure of the current patent document.

### 1. ResNet-20 Compression

The results on ResNet-20, a popular deep neural network with 19 convolutional layers and 1 fully-connected layer, are presented first. Table 1 summarizes results on CIFAR10 and CIFAR100 datasets.

As expected, our tested rank selection embodiment outperformed manually selecting tensor ring ranks for all convolutional layers in ResNet-20. For example, with learned ranks=[10, 11, 9, 10, 7, 2, 2, 17, 4, 7, 9, 12, 11, 6, 7, 11, 7, 12, 7] to decompose 19 convolutional layers, the embodiment compressed more (6× vs 5×) and achieved lower error rate (11.7% vs 12.5%) compared to manually selecting ranks as 10 for all layers. This indicates different layers contain different redundancy and thus better to be compressed with different ranks. Another result on CIFAR10 shows that with the same compression ratio (CR) of 14x, the embodiment achieved a decent 3.6% lower error rate compared to TRN with ranks=6 for all layers. On CIFAR100 dataset, a satisfying result was observed that the embodiment achieved lower error rate with the same CR.

TABLE 1
Tensor ring decomposition for ResNet20
on CIFAR10 and CIFAR100 datasets

| | | | |
|---|---|---|---|
| Method | Params | CR | Error (%) |

CIFAR10

| | | | |
|---|---|---|---|
| Original | 0.27M | 1 | 9.6 |
| TRN (ranks = 6) [1] | 0.02M | 14x | 16.9 |
| TRN (ranks = 10) [1] | 0.05M | 5x | 12.5 |
| Tested Embodiment | 0.02M | 14x | 13.3 |
| (learned ranks) | | | |
| Tested Embodiment | 0.04M | 6x | 11.7 |
| (learned ranks) | | | |

CIFAR100

| | | | |
|---|---|---|---|
| Original | 0.28M | 1 | 34.6 |
| TRN (ranks = 8) [1] | 0.03M | 8x | 41.6 |
| Tested Embodiment | 0.03M | 8x | 38.7 |
| (learned ranks) | | | |

[1] Tensor Ring Nets (TRN) from Wenqi Wang, Yifan Sun, Brian Eriksson, Wenlin Wang, and Vaneet Aggarwal, “Wide compression: Tensor Ring Nets,” in The IEEE Conference on Computer Vision and Pattern Recognition (CVPR), June 2018.

### 2. ResNet-32 Compression

Next, a deeper and larger neural network, ResNet-32, was used. Comparisons with other tensor decomposition methods, such as Tucker decomposition and TT decomposition, were made. The results are demonstrated in Table 2.

It was observed that on CIFAR10 dataset, with 15x compression ratio, the embodiment's results showed an impressive margin of 7.3% lower error rate, compared to manually selecting ranks equal to 6 for all layers. The tested embodiment also achieved much larger compression ratio and similar error rate compared to other tensor decomposition methods, such as Tucker decomposition and TT decomposition. On the CIFAR100 dataset, the embodiment's results once again outperformed some other existing works. The learning-based rank selection embodiment on ResNet-32 was able to achieve higher compression ratio with comparable accuracy compared to that of ResNet-20 since there are more parameters to compress in deeper networks which indicates more redundancy. The framework embodiments presented herein should be able to perform better for even larger networks such as ResNet-152, Wide-Resnet, VGG, etc.

TABLE 2
Tensor decomposition for ResNet32
on CIFAR10 and CIFAR100 datasets

| | | | |
|---|---|---|---|
| Method | Params | CR | Error (%) |

CIFAR10

| | | | |
|---|---|---|---|
| Original | 0.46M | 1 | 7.5 |
| Tucker [2] | 0.09M | 5x | 12.3 |
| TT (ranks = 13) [3] | 0.1M | 5x | 11.7 |
| TRN (ranks = 6) [1] | 0.03M | 15x | 19.2 |
| Tested Embodiment | 0.03M | 15x | 11.9 |
| (learned ranks) | | | |

CIFAR100

| | | | |
|---|---|---|---|
| Original | 0.47M | 1 | 31.9 |
| Tucker [2] | 0.09M | 5x | 42.2 |
| TT (ranks = 13) [3] | 0.1M | 5x | 37.1 |
| TRN (ranks = 6) [1] | 0.04M | 12x | 36.6 |
| Tested Embodiment | 0.04M | 12x | 35.5 |
| (learned ranks) | | | |

[1] TRN - see [1], above, for Table 1.
[2] Tucker: Yong-Deok Kim, Eunhyeok Park, Sungjoo Yoo, Taelim Choi, Lu Yang, and Dongjun Shin, “Compression of Deep Convolutional Neural Networks for Fast and Low Power Mobile Applications,” arXiv e-prints, arXiv: 1511.06530, November 2015.
[3] Tensor Train (TT): Timur Garipov, Dmitry Podoprikhin, Alexander Novikov, and Dmitry Vetrov, “Ultimate Tensorization: Compressing Convolutional and FC Layers Alike,” arXiv e-prints, arXiv: 1611.03214, November 2016.

### F. Some Conclusions

Tensor decomposition has found its wide applications in machine learning field especially for compressing deep neural networks in recent years. In this work, the non-trivial problem of rank selection in tensor decomposition for a set of one or more layers in the deep neural networks was addressed. In one or more embodiments, based on the efficient reinforcement learning agent of DDPG, its specified action space and state space were designed, with the accuracy and parameter size as its reward at the same time. Embodiments of the rank selection framework can efficiently find the proper ranks for decomposing weight tensors in different layers in deep neural networks. Experimental results based on ResNet-20 and ResNet-32 with image classification datasets CIFAR10 and CFIAR100 validated the effectiveness of the rank selection embodiments herein. Embodiments of the learning-based rank selection scheme will perform well for other tensor decomposition methods and should perform well for other applications beyond deep neural network compression.

### G. Computing System Embodiments

In one or more embodiments, aspects of the present patent document may be directed to, may include, or may be implemented on one or more information handling systems/computing systems. A computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, phablet, personal digital assistant (PDA), smart phone, smart watch, smart package, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

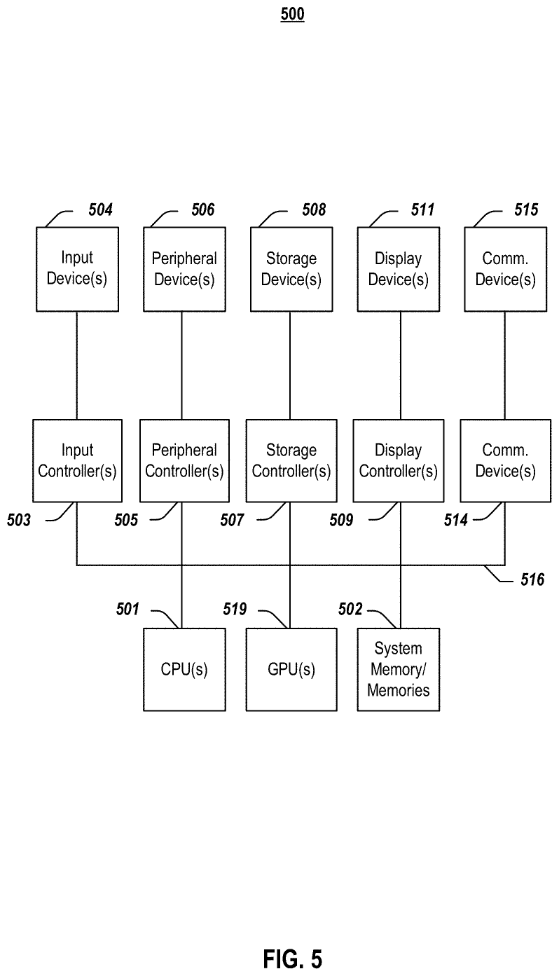

FIG. 5 depicts a simplified block diagram of a computing device/information handling system (or computing system) according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more central processing units (CPU) 501 that provides computing resources and controls the computer. CPU 501 may be implemented with a microprocessor or the like, and may also include one or more graphics processing units (GPU) 519 and/or a floating-point coprocessor for mathematical computations. System 500 may also include a system memory 502, which may be in the form of random-access memory (RAM), read-only memory (ROM), or both.

A number of controllers and peripheral devices may also be provided, as shown in FIG. 5. An input controller 503 represents an interface to various input device(s) 504, such as a keyboard, mouse, touchscreen, and/or stylus. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 508 may also be used to store processed data or data to be processed in accordance with the disclosure. The system 500 may also include a display controller 509 for providing an interface to a display device 511, which may be a cathode ray tube (CRT), a thin film transistor (TFT) display, organic light-emitting diode, electroluminescent panel, plasma panel, or other type of display. The computing system 500 may also include one or more peripheral controllers or interfaces 505 for one or more peripherals 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media may include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for selecting ranks to decompose weight tensors of one or more layers of a pretrained deep neural network (DNN), the method comprising:
embedding elements related to one or more layers of the pretrained DNN into a state space;
for each layer of the pretrained DNN that is to have its weight tensor decomposed, initializing an action with a preset value;
iterating, until a stop condition has been reached, a set of steps comprising:
for each layer of the pretrained DNN that is to have its weight tensor decomposed, having an agent use at least a portion of the embedded elements and a reward value from a prior iteration, if available, to determine an action value related to a rank for the layer;
responsive to each layer of the pretrained DNN that is to have its weight tensor decomposed having an action value:
for each layer of the pretrained DNN that is to have its weight tensor decomposed, decomposing its weight tensor according to its rank determined from its action value; and
performing inference on a target dataset using the pretrained DNN with the decomposed weight tensors to obtain a reward metric, which reward metric is based upon inference accuracy and model compression due to the decomposed weight tensors; and
responsive to a stop condition having been reached, outputting ranks for each layer of the pretrained DNN that had its weight tensor decomposed corresponding to a best reward metric.

2. The computer-implemented method of claim 1 wherein the elements related to the pretrained DNN comprise at least:
for each layer that is to have its weight tensor decomposed:
a layer index;
dimensions of its weight tensor;
a stride size;
a kernel size;
a parameter size; and
an action associated with a previously layer.

3. The computer-implemented method of claim 1 wherein the action value is a continuous value from a continuation action space and the method further comprises:
converting the continuous value of the action value into a rank that is an integer number.

4. The computer-implemented method of claim 1 wherein the weight tensor of a layer is decomposed using tensor ring decomposition.

5. The computer-implemented method of claim 1 wherein the step of embedding elements related to one or more layers of the pretrained DNN into a state space comprises:
normalizing the elements to be within a range of zero to one.

6. The computer-implemented method of claim 1 wherein the step of outputting ranks for each layer of the pretrained DNN that had its weight tensor decomposed corresponding to a best reward metric comprises:
outputting the pretrained DNN with the decomposed weight tensors.

7. The computer-implemented method of claim 6 further comprising the step of:
performing supplemental training of the pretrained DNN with the decomposed weight tensors using a training dataset.

8. A non-transitory computer-readable medium or media comprising one or more sequences of instructions which, when executed by at least one processor, causes steps for selecting ranks to decompose weight tensors of one or more layers of a pretrained deep neural network (DNN) to be performed, the steps comprising:
embedding elements related to one or more layers of the pretrained DNN into a state space;
for each layer of the pretrained DNN that is to have its weight tensor decomposed, initializing an action with a preset value;
iterating, until a stop condition has been reached, a set of steps comprising:
for each layer of the pretrained DNN that is to have its weight tensor decomposed, having an agent use at least a portion of the embedded elements and a reward value from a prior iteration, if available, to determine an action value related to a rank for the layer;
responsive to each layer of the pretrained DNN that is to have its weight tensor decomposed having an action value:
for each layer of the pretrained DNN that is to have its weight tensor decomposed, decomposing its weight tensor according to its rank determined from its action value; and
performing inference on a target dataset using the pretrained DNN with the decomposed weight tensors to obtain a reward metric, which reward metric is based upon inference accuracy and model compression due to the decomposed weight tensors; and
responsive to a stop condition having been reached, outputting ranks for each layer of the pretrained DNN that had its weight tensor decomposed corresponding to a best reward metric.

9. The non-transitory computer-readable medium or media of claim 8 wherein the elements related to the pretrained DNN comprise at least:
for each layer that is to have its weight tensor decomposed:
a layer index;
dimensions of its weight tensor;
a stride size;
a kernel size;
a parameter size; and
an action associated with a previously layer.

10. The non-transitory computer-readable medium or media of claim 8 wherein the action value is a continuous value from a continuation action space and the method further comprises:
converting the continuous value of the action value into a rank that is an integer number.

11. The non-transitory computer-readable medium or media of claim 8 wherein the weight tensor of a layer is decomposed using tensor ring decomposition.

12. The non-transitory computer-readable medium or media of claim 8 wherein the step of embedding elements related to one or more layers of the pretrained DNN into a state space comprises:
normalizing the elements to be within a range of zero to one.

13. The non-transitory computer-readable medium or media of claim 8 further comprising one or more sequences of instructions which, when executed by at least one processor, causes steps to be performed comprising:
performing supplemental training of the pretrained DNN with the decomposed weight tensors using a training dataset.

14. A system comprising:
one or more processors; and
a non-transitory computer-readable medium or media comprising one or more sets of instructions which, when executed by at least one of the one or more processors, causes steps to be performed comprising:
embedding elements related to one or more layers of the pretrained DNN into a state space;
for each layer of the pretrained DNN that is to have its weight tensor decomposed, initializing an action with a preset value;
iterating, until a stop condition has been reached, a set of steps comprising:
for each layer of the pretrained DNN that is to have its weight tensor decomposed, having an agent use at least a portion of the embedded elements and a reward value from a prior iteration, if available, to determine an action value related to a rank for the layer;
responsive to each layer of the pretrained DNN that is to have its weight tensor decomposed having an action value:
for each layer of the pretrained DNN that is to have its weight tensor decomposed, decomposing its weight tensor according to its rank determined from its action value; and
performing inference on a target dataset using the pretrained DNN with the decomposed weight tensors to obtain a reward metric, which reward metric is based upon inference accuracy and model compression due to the decomposed weight tensors; and
responsive to a stop condition having been reached, outputting ranks for each layer of the pretrained DNN that had its weight tensor decomposed corresponding to a best reward metric.

15. The system of claim 14 wherein the elements related to the pretrained DNN comprise at least:
for each layer that is to have its weight tensor decomposed:
a layer index;
dimensions of its weight tensor;
a stride size;
a kernel size;
a parameter size; and
an action associated with a previously layer.

16. The system of claim 14 wherein the action value is a continuous value from a continuation action space and the non-transitory computer-readable medium or media further comprises one or more sets of instructions which, when executed by at least one of the one or more processors, causes steps to be performed comprising:
converting the continuous value of the action value into a rank that is an integer number.

17. The system of claim 14 wherein the weight tensor of a layer is decomposed using tensor ring decomposition.

18. The system of claim 14 wherein the step of embedding elements related to one or more layers of the pretrained DNN into a state space comprises:
normalizing the elements to be within a range of zero to one.

19. The system of claim 14 wherein the step of outputting ranks for each layer of the pretrained DNN that had its weight tensor decomposed corresponding to a best reward metric comprises:
outputting the pretrained DNN with the decomposed weight tensors.

20. The system of claim 14 wherein the non-transitory computer-readable medium or media further comprises one or more sets of instructions which, when executed by at least one of the one or more processors, causes steps to be performed comprising:
performing supplemental training of the pretrained DNN with the decomposed weight tensors using a training dataset.
